(19) United States
(12) Patent Application Publication
(10) Pub. No.: US 2004/0091110 A1
(43) Pub. Date: May 13, 2004

(54) Copy protected display screen

(76) Inventor: Anthony Christian Barkans, Kirkland, WA (US)

Correspondence Address: Anthony C Barkans, 5604 Lakeview Dr #B, Kirkland, WA, 98033, US

(21) Appl. No.: 10/291,325

(22) Filed: Nov. 8, 2002

(51) Int. Cl. H04N 7/167

(52) U.S. Cl. 380/201

(57) ABSTRACT

A display system capable of displaying an image is modified with one or more elements that emit energy (140) that is outside the range of human perception, but within the range that is detected by the sensors used in a mechanical recording device (160). This energy could be in the infrared range of the electromagnetic spectrum. With this modification the display screen (110) will produce two simultaneous, or near simultaneous, images. The first image, seen by a human observer, will differ from the second image captured by the sensors of a recording device, such as a video camera.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to augmenting a display screen with a set of emitting elements that emit energy outside the range of human perception, but within the range of mechanical recording devices, so as to produce two different images. One image is seen by the un-aided eye of a human observer, and would typically be a movie, TV program, still image etc. The second image, as captured by an image recording device consists of the image the human eye can sense and the image created by the emitters. The goal is to hinder pirating by creating the second image, the one sensed by the recording device, where this second image is sufficiently different from the one sensed by an un-aided human eye.

2. Prior Art

Large investments are made to produce movies and other types of images. Often times this content is copied, using a mechanical recording device, by someone other than the original producer of the content. These copies are then sold, or given away, in a process called pirating. The reason for the widespread use of the term pirating is that the lawful owner of the work is not compensated for that work when someone views these pirated copies. With the widespread use of the Internet this is becoming a larger problem, since a single pirated copy of a movie can be placed on a web site and then subsequently copied by anyone in the world with internet access.

To address the issue of piracy, many inventors have created different types of systems. In general these fall into three classes.

The first class of inventions is to encrypt the data as it is transmitted to a display. The idea is that if the encrypted data is intercepted the original data can not be viewed. Typically the data to be protected is transmitted in a digital form and relies on the use of a trusted mechanism to pass the encryption and decryption keys through the system. There are several industry-wide initiatives that address the use of this technique under the heading of “digital rights management”. In addition several inventors have applied these ideas to individual systems such as disclosed in U.S. Pat. No. 6,229,895 to Son et. al.

The second class of inventions is to modify the electrical signal used to transmit the image so that the modified signal is used disrupt image quality. For example U.S. Pat. No. 5,206,907 to Hashimato discusses digital logic to modify a video signal. An analog technique is discussed in U.S. Pat. No. 5,625,691 to Quan. Note that the Hashimato invention is directed towards protecting content on a Cable TV system while the Quan invention is directed towards preventing the use of a video recorder (often called a VCR for Video Cassette Recorder). Note that one of the earliest inventors to modify the electrical proprieties of the video signal in an effort to deter pirating was Ryan as disclosed in U.S. Pat. No. 4,577,216.

Of particular interest is Ryan's invention. His basic idea is to modify the electrical signal, so that there is a difference in image quality when the signal is feed directly to a television (TV) set, as compared to when the signal is first recorded and then played back using a video recording device before being sent to a TV set for display. In the case where a recording device is used, Ryan is counting on the difference in the way the color burst signal is used within a video recorder when compared to the way the same signal is used within a typical TV set. By exploiting this difference, he had one of the first commercially successful anti-pirating systems. However, there are two drawbacks to this type of system. The first drawback is that there is the assumption that when a high quality image is sent to a display (such as using Ryan's modified signal to directly drive a TV, as opposed to using the recording device to playback the signal) that the viewer is assumed to be trusted with the data. [By “trusted with the data” it is meant that the viewer is not attempting to use the data on the viewable display screen in order to make pirated copies.] The second drawback is that the system relies on very specific aspects of the way various electronic equipment processes the electrical signals that are used to transmit video data. For example, Ryan's invention exploits the differences between the way a signal is processed inside a TV set and the way the same signal is used in a VCR. The way this is done in Ryan's system is by noting that the color bust signal, which is only used to adjust the color in a TV set, is also used to regulate the playback speed of the magnetic head of a video recorder. This is a drawback because if a user had a system with Ryan's modified video signal and replaced their magnetic tape based system (VCR) with a newer system without a magnetic playback head, such as a Digital Video Recording device (DVD), then Ryan's system won't work.

The third class of copy protection is called watermarking. This is where a feature is added to image data so that a pirated copy can be traced back to the source of the copy. For example U.S. Pat. No. 6,272,634 to Tewfik discloses a digital watermarking technique.

To summarize the above three classes of copy protection. One common thread running through the first two of the above techniques is that protection is applied to the data as it is sent to an intended display. However, when the image data is displayed is on the intended display, it is assumed that the viewer is trusted. Note that in this sense a trusted viewer is defined to be someone not trying to pirate the data being displayed on the screen. The third technique, watermarking, recognizes that once data is displayed it may be improperly copied (pirated). However, the idea behind watermarking is much like the idea behind branding cattle. It doesn't prevent stealing, it only aids in prosecuting the thief once that thief is caught.

While several techniques have been applied to preventing video piracy, there has been a separate series of innovations related to modifying displays to achieve various effects. For example, by the 1950's people were producing silvered screens to preserve the polarization of light for 3D movies. More recently U.S. Pat. No. 6,459,532 to Montgomery et al. discusses additions to a display screen to allow the display of autostereographic images. While these two examples discuss 3D displays, other inventions have taken advantage of the magnifying properties of Fresnel lens, and the light distribution of glass beads etc. The common thread in these innovations has been to optimize some property of the display to produce a specific effect for a human viewer.

### OBJECTS AND ADVANTAGES OF THE PRESENT INVENTION

Several objects and advantages of the present invention are:

(a) To provide a display system that provides protection from mechanical reproduction as an image is being displayed on an intended device.

(b) To provide this protection without degrading the visual quality of the image for the intended human viewer.

(c) To provide this type of protection across a board range of display devices.

(d) To protect against copying by a broad range of recording devices.

### BRIEF SUMMARY OF THE INVENTION

In accordance with the present invention a display system capable of displaying an image is modified with one or more elements that emit energy that is outside the range of human perception, but within the range that is detected by the sensors used in a mechanical recording device. In addition to the new emitters, the display is also equipped with a mechanism to control the emitting element, or elements.

### DRAWINGS

In the Drawings, closely related figures have the same number but different alphabetic suffixes. In addition several of the drawings show variations of the basic technique. In these drawings the same numbers are used to represent the same elements. For example the emitter shown as number 140 in FIGS. 2, 3 and 5, refers to the same emitter.

FIG. 1A shows the sensitivity of the human visual system across a range of wavelengths.

FIG. 1B shows the sensitivity of a typically Charged Coupled Device (CCD) used as an image sensor in a digital video camera.

FIG. 1C shows the output of a typically LED designed to emit energy in the Infrared (IR) range.

FIG. 2 schematically shows a typical movie theater with the screen modified in accordance with the current invention.

FIG. 3 schematically shows the same movie theater as shown in FIG. 2, but with a programmable controller added to the invention.

FIG. 4 schematically shows this invention utilized in a TV set.

FIG. 5 schematically shows the same theater as shown in FIG. 2 and FIG. 3, but with a modified projector.

### THEORY OF OPERATION

Note that this theory is presented to provide an overview of the mechanism behind this invention. To meet this goal the theory presented here isn't numerically precise. Instead several approximations have been made in order to focus on the important features that are used by this invention.

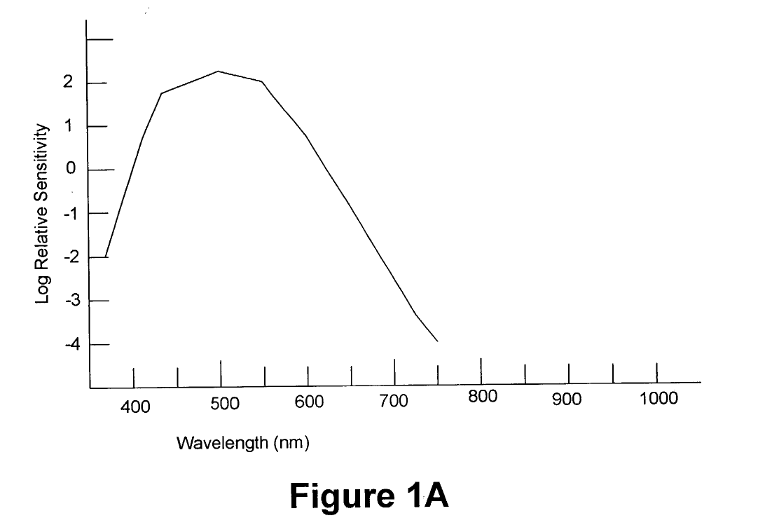

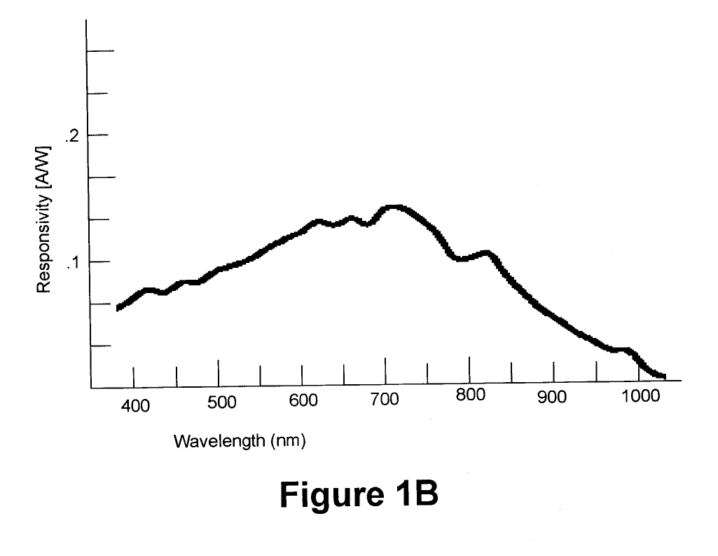

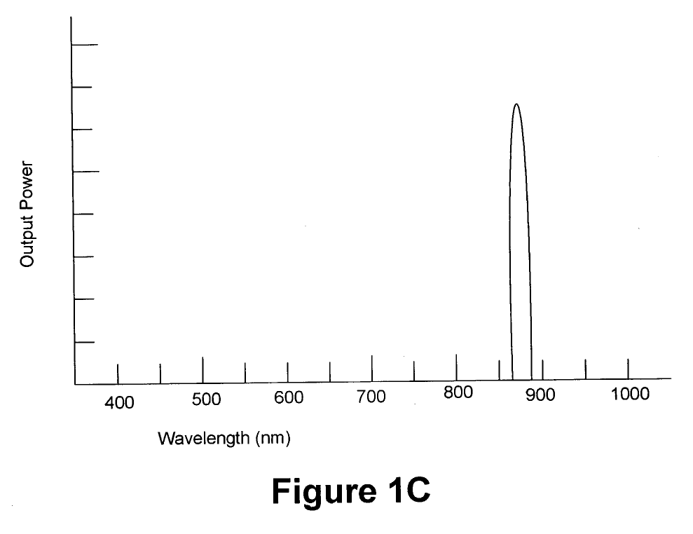

Defining the exact sensitivity of the human eye to various wavelengths of light is nearly impossible to do. For one thing individuals have differing sensitivities. Also within any single individual their eyes have both rods and cones. In turn these have differing sensitivities. As such FIG. 1A is a composite based on several physiological studies. However, for the current invention the exact shape of the curve shown isn't as important two unique proprieties. These are: first the sensitivity of the eye to light of various wavelengths is shown on a logarithmic scale. Note that in FIG. 1A the typical human eye is about 10,000 times more sensitive to light with a wavelength of 500 nm than to light at 750 nm. The second important datum is that the range of wavelengths that the eye is sensitive to is restricted to a well defined range. Various physiological studies have shown that range to include wavelengths from about 400 nm to 750 nm.

One important aspect of the human eye is that it is a biological device made up of various organic compounds. However, modern semiconductors are mechanical devices composed primarily of inorganic compounds. The use of these different compounds gives rise to differences in the way these devices behave. For example FIG. 1B shows the sensitivity of a CCD imaging array to various wavelengths of light. In this example the data is shown for a part made by Texas Instruments Corporation and is sold as part number TC237B. Note that the selection of this particular device is for illustrative purposes and other than it shows the proprieties that are exploited by this invention; there is nothing that makes this part critical for this invention. Also note this device is typical of what would be used as the image sensor in a typical digital video recording camera.

A person, skilled in the art, would readily understand the details shown in FIG. 1B. However, for the purposes of this invention we need only examine two aspects of the figure. First the sensitivity is shown on a linear scale and not a logarithmic scale. This means that the device is about half as sensitive to light at one end of the human visual spectrum when compared to the device's sensitivity at the other end of the spectrum. For this particular device that is that the sensitivity to 400 nm wavelength of light is about one half as sensitive as to light at 750 nm. Note that this compares with the human eye where the sensitivity falls off logarithmically, with the sensitivity to light at 750 nm being approximately 1,000 times less sensitive than to light at 500 nm. The second important feature of this device is that the device is sensitive to light well outside the range of the human eye. For example the human eye has peak sensitivity to light at about 500 nm and has no sensitivity to light at 875 nm. On the other hand the CCD is just slightly less sensitive to light at 875 nm than to light at 500 nm.

FIG. 1C shows the output of an infrared emitting diode. Note these devices are often called IR LEDs, for infrared light emitting diodes. In this case the output is shown for a part made by Agilent Technologies and designated as part number HSDL-4230. It is used for illustrative purposes. The most important point to note from FIG. 1C is that the light emitted from this particular part is centered at 875 nm. This particular wavelength is outside the range of sensitivity of the human eye, but well within the range of the CCD device discussed in relation to FIG. 1B.

The essence of this invention then is to exploit the differences in sensitivity between recording devices, such as video cameras, and the human eye. This is done by augmenting a display device with emitting devices that alter the image as perceived by a recording device when compared to the same image as perceived by a human observer.

### DETAILED DESCRIPTION OF THE INVENTION

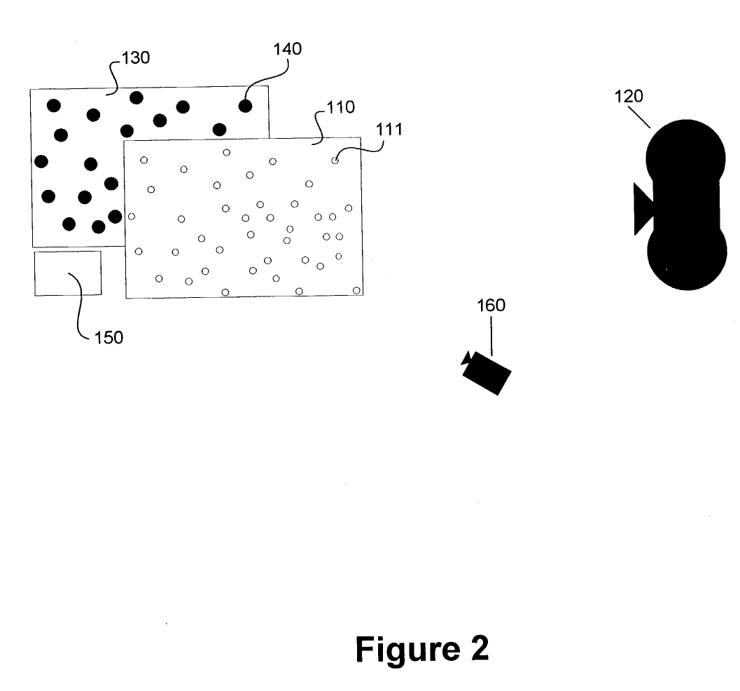

FIG. 2—The Preferred Embodiment

The preferred embodiment of the present invention of a content protected displayed screen is illustrated in FIG. 2. The figure is a schematic view of a movie theater. The display screen 110 would be the movie projection screen that the audience would be watching. The movie would be projected by the projector 120. Both of these elements, the projector 120 and screen 110 could be the existing items that are in a typical movie theater. In accordance with this invention an array of emitting elements 130 would be placed behind screen 110. This grid of emitters would be made of a plurality of individual emitting elements 140. In the preferred embodiment the array 130 would consist of an array of individual elements 140 that emit light at approximately 875 nm.

Note that in some cases the existing screen in a movie theater would be made of a meshed material that would allow the light from the emitters in gird 130 to pass through. In other cases screen 110 would need to be modified to have small perforations. In either case there would be holes 111 (or translucent material) in screen 110 corresponding to the locations of the individual emitters 140 in grid 130. Ideally these openings 111 would be located to allow most of the emitted energy from each emitter 140 to be directed to the areas of the theater where the movie being shown on screen 110 could be recorded.

It should be noted that the goal is to disrupt the recorded image, so that the array 130 of emitting elements could include thousands of individual emitters. In addition these elements should be distributed to cover the area of the entire display screen 110.

This invention does not require any modification to the standard electrical connections used to power the emitters. As such one skilled in the art would have ready access to the relevant information on how to create the necessary electrical connections needed to assembly controller 150. For example, details on the electrical characteristics and support circuitry required to use the Agilent IR LED discussed in relation to FIG. 1C can be obtained from the manufacturer. One source of information is their web site at www.semiconductor.agilent.com which contains detailed data sheets and application notes. Of particular interest for this invention is Agilent Technologies Application Note #1113 titled “Infrared Transceiver Distance and Power Consumption Tradeoffs”. This application note is of particular interest since it discusses connecting these diodes in parallel in order to increase their effective transmission range. Since this invention could be placed in a large movie theater the range of transmission would be an import attribute. In addition the various data sheets discuss the current requirements, voltage and duty cycle that these particular parts require. In addition other vendors of other emitters have their own sets of corresponding technical information.

Although not a required part of this invention, a recording device 160 that can detect the image on the display is shown in FIG. 2. This is shown since pirates could be using this type of device. One important criterion for selecting the appropriate emitting elements for array 130 would be based on understanding the characteristics of the typical recording devices that might be used in an attempt to pirate a movie that is being shown in a theater utilizing this invention. For example the typical video recorder used in 2002 will detect and record light at 875 nm. Note that this wavelength, in the infrared part of the electromagnetic spectrum, is outside the range of human perception, but with the range where it will be detected by an image recording device, such as a video camera. Moreover, if the 875 nm emitter is bright then the typical video recorder will saturate at the point where the emitter appears in the image, resulted in a very bright white smear over part of the image. Note that this white smear captured by the recording device 160 would be obscure part of the image that would appear normal to a human observer sitting in the audience and watching a movie projected on the display screen 110.

Note that currently IR LEDs that emit light at 875 nm are readily available. This makes IR LEDs that emit at 875 nm a good choice to use for array 130 for the year 2002.

Additional Embodiment—A Complex Controller

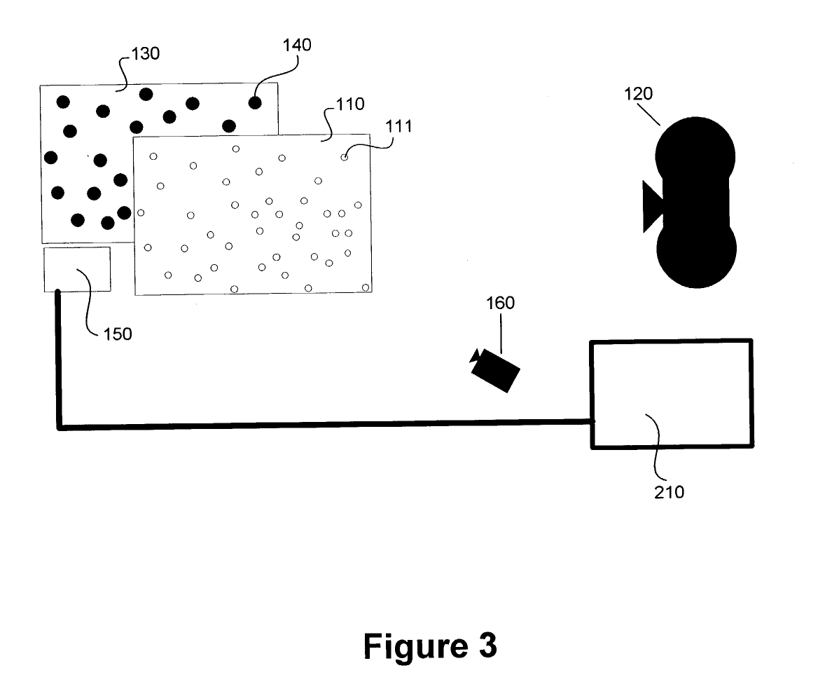

For additional anti-pirating protection the controller 150 in FIG. 2 could be made more complex. Ideally there could be a micro-computer controlling a set of programmable switches, where there would be one programmable switch per emitting element in array 130. [Note there are currently many commercially available micro-computers with programmable switches that a person skilled in the art could select from.] This is shown in FIG. 3, where the programmable device, computer 210, has been added to the system shown in FIG. 2. In this modified system, the emitters in array 130 would be programmed (using computer 210) so that the emitted light from array 130 would be altered over time. The alterations would be designed to make it difficult to apply image processing algorithms to a pirated copy taken by recorder 160 of the augmented display screen 110.

To see the value of this modification assume that the emitters of array 130 were to flash rapidly and randomly. In this case someone with advanced knowledge of image processing could reconstruct part of the original image using a pirated copy of a movie obtained by recorder 160. To show this, imagine that a movie is being shown and there is a patch of blue sky. If the pirated copy of the movie showed random white spots in the blue field, then an algorithm could be designed to assess the colors around the white flashes within any one frame, and to assess the time varying nature of that region of the scene. If the area surrounding the white flash is blue, and then it is observed that in frames where the flash doesn't show-up that the area and its surroundings are blue, then a reasonable approximation is that the bright flash recorded in the pirated copy is obscuring part of the blue sky.

To address the issue of reconstructing the movie using image processing techniques, an approach would be to incorporate the time varying proprieties of a movie into the switching algorithm used in the computer 210 controlling emitter array 130. For example individual emitters 140 that appear behind the eyes of the important actors could be enabled whenever these actors are on screen. If there are enough emitters, the eyes could be completely obscured in a pirated copy of display screen 110 made by recorder 160. Since eye expression is a key feature that audiences watch, a pirated copy missing this feature would be of little use. Note that this would require significant programming effort, but it would be clear to anyone skilled in the art that software designed for feature tracking (in images and movies) is a well understood art. It would then be obvious that the same types of feature tracking algorithms used to locate parts on a moving assembly line could be used to locate eyes (or other features) in a movie. The feature location would then be used as a mask to enable the emitters in that region of the display screen.

Note a conceptually simpler approach for programming the computer 210 would be to play a movie one frame at a time. Then as each frame is displayed a person could manually select which emitters should be enabled when that particular frame is displayed. The individual selecting the emitters could use a recording device similar to the recorder 160 in order to see the results of enabling the various emitters. Then once the entire movie has been stepped through, the set of emitters that is selected to be enabled for each frame would be saved by computer 210 and played back as the movie is run at normal speed. Note that the results of this manual method would be similar to the automated approach discussed in the preceding paragraph. However, it would be much more labor intensive.

In addition the programmable controller could be programmed to use the emitting elements of array 130 to provide watermarking information.

While this discussion has talked of programming the programmable computer, it should be obvious to one skilled in the art, that the program controlling the emitting elements could be received along with the movie. If it is a digital movie that is being broadcast using a satellite then an additional track could be sent to with information that computer 210 would use to controller the emitters 130. Note that the watermarking could still be applied locally, so that the watermark could record where and when the movie was copied.

FIG. 3—Additional Embodiment, A Modified TV Set

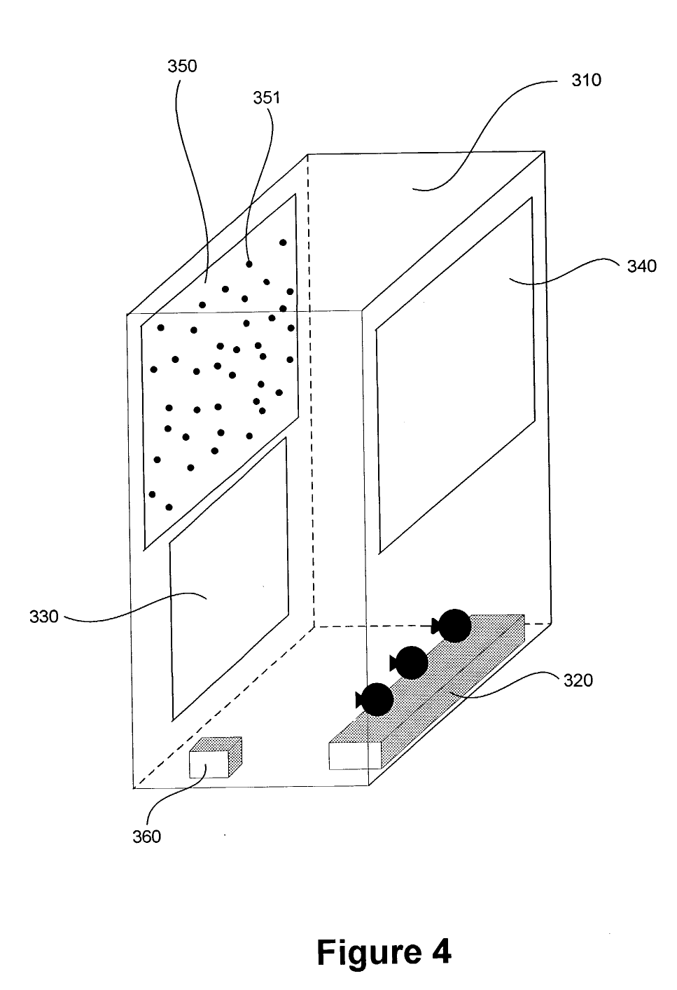

A second embodiment of this invention would be to include it in a TV set. FIG. 3 shows this embodiment. In this case a rear projection TV 310 is shown. A typical TV of this type includes an image projection element 320, a mirror 330 to direct the image from the projector 320 to the display screen of the television set 340. Note that the projection element 320 would include the tuner logic and other circuitry that is common to TV sets. In accordance with this invention an array of emitting elements 350 would be added behind the display screen 340. This array would consist of individual emitters 351. In FIG. 4 array 350 is shown separate from the mirror 330. However, if physical space is a concern then array 350 could be incorporated into the mirror. For example a series of very small holes could be drilled into the mirror and the emitting elements 351 placed to emit through these holes. Note these emitters could be the same, or similar, to the emitters 140 shown in FIG. 2. In addition a controller 360 would be added to the TV set. Its function is to control the array of emitting elements. Controller 360 would be similar in function to the controller 150 shown in both FIG. 2 and FIG. 3.

Additional Refinement for Adding this Invention to a TV Set

One aspect of adding this invention to a TV set is that modern TV sets already have a complex controller. In addition to other tasks this controller is used to report the capabilities of the TV set back to other devices that are connected to it. For example, a modern TV can be connected to a modern DVD player. The DVD can then query the TV set (using a predefined electrical protocol). The TV set can then report back the various screen resolutions that it supports. This is used today so that a movie can be played back at lower quality on an old TV set, including those that don't support this reporting protocol. However, on a TV that supports a high definition mode, and is able to have that information reported to the DVD player, the DVD player can output a movie in higher quality. Another area where using the device capabilities reported by a TV is to obtain knowledge about support for a secure (encrypted) link between the TV and the device (such as a DVD player, computer etc) driving it. In general if a secure link can be established then the connected device can send high quality images to the TV. On the other hand, the same device (DVD, Computer etc) connected to a TV without a secure link could send lower quality video. In this sprit, the inclusion of the current invention could be indicated by a display-device attribute and the quality of the video sent to the TV could be selected based on this new attribute and the other existing attributes.

Note that the concept of reporting the capabilities of the display device has already been extended to copy protection (for example see the definition of the VIDEOPARAMETERS data structure supported in Microsoft's Windows XP operating System). Although this particular device capability was designed for a different copy protection mechanism than this invention proposes, it is an indication that adding this invention as a display capability would fit within the current trends of video protection and the consumer electronic equipment market.

Additional Embodiment Number 3, Protecting Static Image Displays

The previous embodiments discussed utilizing the current invention in a system with time varying content, such as that shown in a movie theater or on a TV set. However, it should be clear that there may be cases where someone would like to utilize this invention with static images. In that case a light box could be designed that supports the emitting array and its controller. In this case the emitters could be simply glued to the back of the light box and a simple controller that provided the correct voltage, current and duty cycle for the emitters could be designed by anyone skilled in the art.

Additional Embodiment Number 4, Monitoring the Output of the Emitter Array

While it is clear that goal of this invention is to interfere with the recording, and thus pirating, of image data it should also be noted that the secondary image produced by the array of emitters 130 in FIG. 2 can be used to farther enhance the invention.

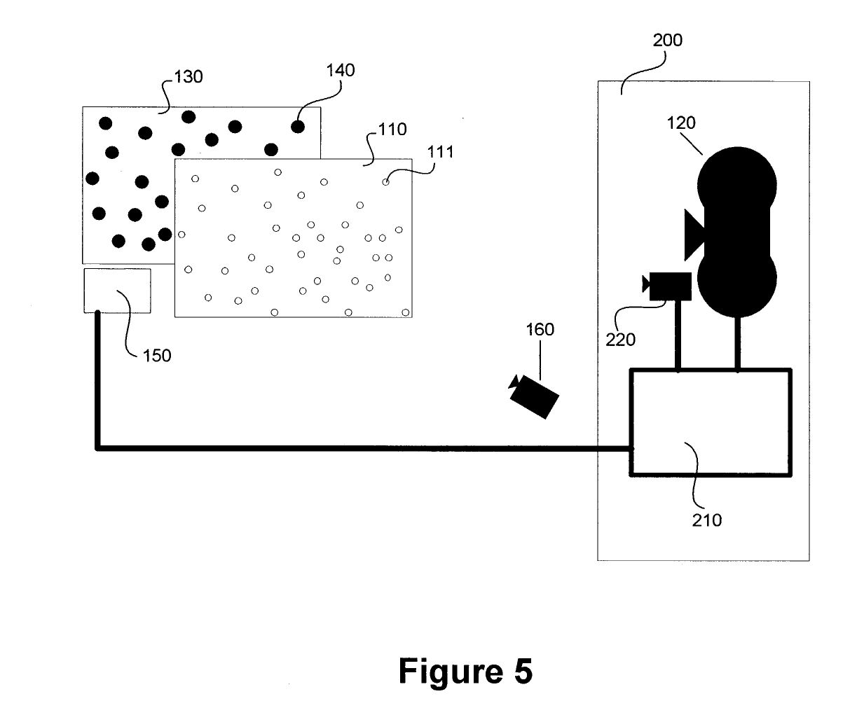

Referring back to either FIG. 2 or FIG. 3, a system is shown that would work to stop an individual pirate, but raises the questions, of “what if the theater owner is the pirate?” In the embodiment shown in FIG. 2, a corrupt theater owner could simply disable controller 150 and then project the movie while using recording device 160 to make a pirated copy. To prevent this projector 120 could be modified as shown in FIG. 5. The modified projector 200 would include the conventional projection elements 120. In addition an image sensor 220 that is similar to the one in recording device 160 would be added to computer 210. These additional elements (sensor 220 and computer 210) would be closely coupled to projector 120 forming a new projector system 200. The sensor 220 would be connected to the programmable computer 210. This would then be linked with the controller 150.

In this embodiment the controller 150 would be a slave of the programmable computer 210 in the modified projector 200. For this embodiment a program running in computer 210 would control the individual emitters 140 through the circuitry in controller 150. However, when the computer 210 is coupled with sensor 220 it could also be used to determine programmatically which emitting elements in array 130 are emitting. In this embodiment, the programmable computer 210 could be used to control the light inside projector 120. If the image sensed by sensor 220 isn't as expected the light in projector 120 could be turned off under control of the programmable computer 210.

Note that computer 210 and sensor 220 could be put together with currently available commercial image processing systems. These systems can be purchased, complete with sensors (often a CCD camera and supporting hardware to transfer the camera data into the memory array of a standard PC). These systems are available from several manufacturers and are designed to be programmed by anyone that is skilled in the art. However, it would be desirable to physically connect these two parts of the system (computer 210 and sensor 220) closely with projector 120. The goal would be to make it harder for the average corrupt theater operator to tamper with the anti-pirating protection that this invention provides.

Adding the Monitoring of the Output of the Emitter Array to a TV Set

The idea of monitoring the emitter array can also be applied to a TV set. In this case the equivalent of sensor 220 would be placed inside the TV set, much the same as current TV sets employ sensors for the auto-focus mechanism. However, instead of sensing the electron beam, as in the auto-focus designs, the sensor would be sensing the output of the emitting elements.

Alternative Embodiment—Using Different Types of Emitters

While it is clear that selecting the emitting elements such that they emit energy outside of the range of the human eye has several advantages, it should be noted this isn't the only option. Note that adding emitters that emit energy in the wavelengths where the human eye is losing its sensitivity has other advantages. For example overlaying a red part of an image with bright red emitters can have similar effects as the use of emitters that emit at a wavelength outside the range of the human visual system. In this example the human eye is easily saturated, and so the additional red isn't noticeable. However, a mechanical recording device would still be sensitive to the additional red. In particular this additional light energy can interfere with the workings of the recording device, such as it can interfere with the automatic gain control (AGC) system. The result is that the recorded image is substantially different from the original image as perceived by a human observer.

### CONCLUSION

From the description above, a number of advantages of this invention became obvious:

(a) When a pirate tries to record data from a system using this invention the image captured by the recording device will be significantly different from the image that a human observer will see. When this system is used with the goal of preventing pirating, the recorded image quality captured by the pirate can be degraded to a point that the pirated copy is difficult to watch. The advantage is that it discourages pirating.

(b) Another advantage is that images shown to the legitimate viewer are not affected by this anti-piracy system. Oddly enough this means the human pirate that may have paid the legitimate price of admission to view a movie could watch it, but the pirate's camera would not capture the same image that the pirate would be seeing.

(c) This system can be applied to a variety of display devices.

(d) As different recording devices are considered (or introduced in the future), the emitting devices of the current invention can be adjusted to account for the characteristics of these various recording devices.

Although the descriptions above contain many specificities, these should not be constructed as limiting the scope of the invention but as merely providing illustrations of some of the presently preferred embodiments of this invention. For example the emitters could be other than infrared light emitting diodes (IR LEDs), and the wavelengths emitted could be different than those discussed etc. In addition the emitters don't need to be behind the display screen, but could be integrated into it, or placed around it. In fact, due to the small physical size of some emitters, the emitting elements could be placed on top of some display screens. In addition the display device could be other than in a movie theater, TV or light box. For example the display could be a computer display with either a CRT or LCD. Thus it will be appreciated that various modifications and alterations might be made by those skilled in the art without departing from the spirit and scope of the invention. The invention should therefore be measured in terms of the claims which follow.

I claim:

1. A display system comprising:
a. a means to show an image on a display and
b. a means to augment said display with at least one emitting element that emits energy that is outside the range of human perception, where said energy can be detected by an image recording device and
c. a means to activate said emitting element.

2. The display system of claim 1 wherein the activation means for said emitter of energy is a programmable device with means to control individual said emitting element.

3. The display system of claim 1 wherein said energy is emitted by a plurality of emitting elements.

4. A display system of claim 1 wherein said display is a movie projection screen.

5. A display system of claim 1 wherein said display is a display screen of a television set.

6. A display system of claim 1 wherein said display is a display screen of a computer.

7. A display system of claim 1 wherein said display is a light box.

8. A display system of claim 1 wherein said display system with means to use predefined electrical protocol to report the display screen copy protection capability of said display system.

9. A display system of claim 1 wherein said emitting element or elements are light emitting diodes that emit in the infrared range of the electromagnetic spectrum.

10. A display system of claim 1 wherein the said display image is projected by a projector.

11. A display system of claim 10 wherein the said projector contains means to sense the said emitted energy from said emitting element.

12. A display system of claim 10 wherein the said sensing of said emitted energy in said projector is used to control said projector.

13. A display system of claim 1 wherein the said display image is part of a television set.

14. A display system of claim 13 wherein the said television set contains means to sense the said emitted energy from said emitting element.

15. A display system of claim 13 wherein the said sensing of said emitted energy in said television set is used to control said television set.
